(19) United States
(12) Patent Application Publication
(10) Pub. No.: US 2010/0112879 A1
(43) Pub. Date: May 6, 2010

(54) BUOY FOR MOORING AND SUPPLYING SERVICES TO PLEASURE CRAFT

(76) Inventors: Rodrigo Baeza Ochoa De Ocariz, Madrid (ES); Jose Ignacio Monedero Montero De Espinosa, Madrid (ES); Jose María Saez Vicente-Mazariegos, Las Rozas (Madrid) (ES); Jose Manuel Chinchilla Alvargonzalez, Torrelodones (Madrid) (ES)

Correspondence Address: FISH & RICHARDSON PC, P.O. BOX 1022, MINNEAPOLIS, MN, 55440-1022, US

(21) Appl. No.: 12/594,148

(22) PCT Filed: Mar. 27, 2008
(86) PCT No.: PCT/ES08/00179

§ 371 Date: Sep. 30, 2009

(30) Foreign Application Priority Data
Apr. 2, 2007 (ES) P200700868

(51) Int. Cl. B63B 22/02; B63B 22/24; G05B 19/00

(52) U.S. Cl. 441/4; 340/5.2

(57) ABSTRACT

A buoy for mooring and supplying services to pleasure craft includes: a body; a lower ring having a chain joined thereto, said chain terminating in an upper ring of a mooring post that rests on the seabed; an upper retractable mooring ring; and a removable satellite element, by means of which the craft is provided with drinking water hoses and electrical ducts that are joined to a branch duct of a distribution network, which extends from a connection cabinet located on land to the buoy. The ascending branch is joined by means of clamps to the mooring chain of same. The above-mentioned hoses and ducts and a steel safety cable can be wound around/unwound from a rotary drum housed inside the buoy. The buoy can be used at marinas, coves or similar locations to increase the number of mooring places available.

### TECHNICAL FIELD

The present invention relates to the general design, the installation and the operation of a buoy for the mooring of pleasure craft, which also facilitates their supply in a simple and safe way both of drinking water and electricity at a reduced cost and without permanently affecting the environment.

### BACKGROUND

In technical literature, typical of specialized publications and patent documents, numerous embodiments are disclosed for the loading/unloading of different products to/from vessels, designed for the transport of fluids, to/from certain land facilities, using for this purpose mooring buoys joined to the corresponding ducts which communicate said vessels with said facilities.

### SUMMARY

Based on this general idea, and bearing in mind the saturation of pleasure craft that usually occurs in almost all marinas in the periods regarded as high season, the present invention has been developed to give a suitable, economical, easy and convenient response to this particular problem of momentary excess demand of the services provided by these marinas.

In order to increase the mooring places in those particular periods without the need to expand dikes, breakwaters and jetties, which is highly expensive and permanently affects the environment, the present disclosure provides supplementary mooring, for the craft that cannot access any of the places located beside the jetties of the marina as they are all busy or set aside, to special buoys moored in sheltered marine spaces such as coves, and also in port areas protected by their dikes or breakwaters.

Special buoys are the fundamental elements of the system and are composed of a body, for example, spherical, in a plastic material, and of a basically standard construction; a lower element for fastening the chain from a mooring post; a trunk-conical protection bell, which protects the connection hoses and ducts and prevents fraudulent mooring; a retractable ring, which is the mooring element of the craft, and a satellite for the indicated supplies.

A twin-tube (for drinking water and electricity) reaches the buoy vertically joined to a distribution network, a twin-tube which is solidly joined to the chain by plastic clamps, so that the swing of the craft cannot damage the corresponding connection hoses and ducts.

Within the field of the invention, three satellite models have been provided: TM, without meters; DN, with drinking water and electricity meters and data transmission via radiofrequency, which are collected by the antenna of an emitter/receiver located in the connection cabinet, located on land, and ESP, with drinking water and electricity meters and data transmission by mobile phone (by SMS messages).

The system indicated will enable simple and safe mooring of the pleasure craft and the supply thereto of drinking water and electricity, in very similar conditions to those that could be provided if they could be moored to the jetties in a marina.

The following figures, of an illustrative and non-limitative nature, can be envisaged on the attached drawing sheets for better understanding of that described and claimed in this specification:

### DESCRIPTION OF DRAWINGS

FIG. 1.—Corresponds to a diagram showing an elevation view of the connection cabinet, the supply distribution network, and the buoys joined by their chains to their respective mooring posts, as well as the lines representing both high tide and low tide.

FIG. 2—Corresponds to a diagram showing a plan view of the connection cabinet, the supply distribution network, and the buoys joined by their chains to their respective mooring posts, as well as the lines representing both high tide and low tide.

FIG. 3.—Corresponds to a diagram relating to the deactivated position of the retractable mooring ring.

FIG. 4.—Corresponds to a diagram related to the activated position of the retractable mooring ring.

FIG. 5.—Corresponds to a diagram showing an elevation view of the constructive details of the supply network, observing the drinking water and electricity supplies, and the possible landline connection to the connection cabinet, as well as the twin-tube for supplies to the satellites of the drinking water and electricity buoys.

FIG. 5a.—Corresponds to a V-V section of FIG. 5

FIG. 6.—Corresponds to an elevation view of a buoy with all its component elements, both upper and lower.

FIG. 7.—Corresponds to a plan view of a buoy with only its upper component elements.

FIG. 8.—Corresponds to an elevation view, clearly sectioned, of a buoy, wherein its satellite appears suitable contained.

FIG. 9.—Corresponds to an elevation view, clearly sectioned, of a buoy, wherein its satellite appears suitable removed.

Therein, the following elements or indications are designated with the indicated references:
1.—Distribution network.
2.—Buoy.
3.—Mooring post.
4.—Connection cabinet.
5.—Low tide line.
6.—High tide line.
7.—Opening direction.
8.—Relay.
9.—Spring.
10.—Watertight area.
11.—Antenna for emission/reception of radiofrequency.
12.—Twin-tube (drinking water+electricity).
13.—Drinking water and electricity supplies.
14.—Telephone connection (depending on the case).
15.—Chain.
16.—Plastic clamp.
17.—Twin-tube intake connection.
18.—Satellite element.
19.—Retractable ring of the buoy.
20.—Protection bell.
21.—Watertight covers.
22.—Socket for drinking water.
23.—Socket for electricity.
24.—Chamber for the moving handle.
25.—Steel safety cable.
26.—Collector rotary drum.
27.—Chain fastening part.
28.—Moving handle

### DETAILED DESCRIPTION

The system for mooring and supplying services to pleasure craft, described and claimed herein, can be reflected with detailed explanatory character in the following summary, which is stated in full detail below.

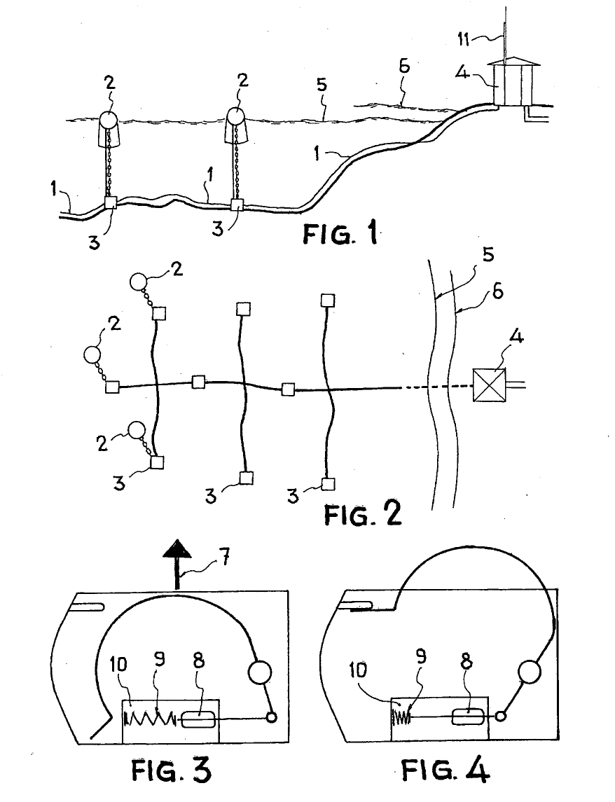

It can start from a supply distribution network (drinking water+electricity) (1), laid, after a buried section, along the seabed, from a connection cabinet (4), a network which extends to the mooring posts (3), which join, by means of a chain (15), the corresponding buoys (2), as can be seen in FIGS. 1 and 2.

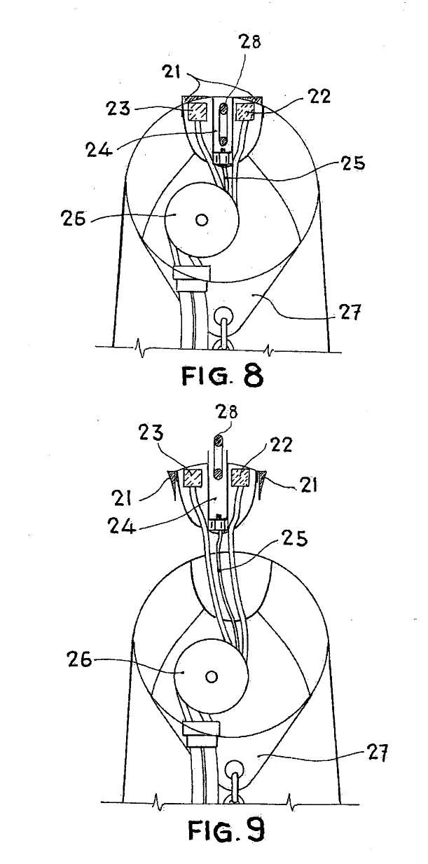

The planned operation of the system that concerns us is very simple. As shall be specified later on (FIGS. 6, 7, 8 and 9), the buoys have a retractable ring (19), which constitutes the mooring point of the craft, and a satellite element (18), wherein the sockets for the supply of drinking water and electricity (22, 23) are located.

For reasons of safety against electrical accidents, this last socket (23) can be situated within a watertight box (not represented in the figures), provided with a hermetic lid, which will avoid, in the event of accident dropping of the satellite element (18) in the sea, that the active elements of the socket (23) can establish electrical contact with the seawater.

The mooring of the craft can be performed by activation of the retractable ring, an activation which, in general, can be carried out by remote control and, in particular, manually. In the first case, actuating the corresponding mechanism, by radiofrequency, from the connection cabinet (4); in the second, releasing the lock manually on the buoys.

Once the retractable ring has been released, the user can firmly tie an end on it, the suitable mooring thus being performed. In any case, activation of the retractable ring can also release the possibility of extracting the satellite element (18) by a moving handle (28), which will allow use of the supplies of drinking water and electricity. Said moving handle (28) can also be used to secure the satellite element (18) to the craft during the mooring thereof.

The connection cabinet (4) can be prefabricated, in accordance with required standards, and it will be placed on concrete foundations, which will be designed depending on the characteristics of the land and of the connection cabinet.

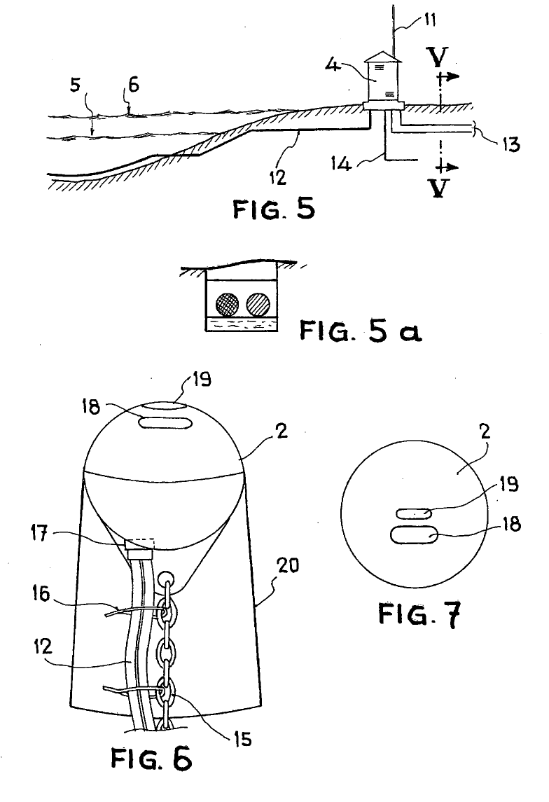

The following elements can be placed inside (according to FIGS. 5 and 5a):

1.—Drinking water and of electricity supplies (13), equipped with the protection, control, manoeuvring and measurement elements required by the current technical regulations and the corresponding supply companies.

2.—Telephone connection (14), which, depending on the case, can be from landline or mobile phone.

3.—Radiofrequency emitter/receiver, with its outer antenna (11), for action on the buoys.

4.—Radiofrequency communications control system between the cabinet, the buoys, the craft and the system control centre.

The distribution network (1) can start from the connection cabinet (4) and can carry the drinking water and electricity supplies to each buoy (2). It will form a distribution network (1) constituted by a twin-tube (12), installed on the seabed until the mooring post (3) of each buoy. From the mooring post, it will continue attached to the chain (15) of each buoy and can rise until it. These vertical sections can be conveniently joined to watertight and fast coupling sockets (22, 23) fixed to the satellite element.

Inside each buoy (2) a collector rotary drum (26) can be placed of the drinking water hoses and electricity ducts. On removing the satellite element (18), the drum can rotate releasing the hose and duct; in contrast, when the user returns the satellite element, the drum can rotate in opposite direction, due to the action of an inner spring, coiling the hoses.

The satellite element can be joined to its respective buoy by a steel safety cable (25), installed on the collector drum; this cable will be unwound and wound on the drum at the same time as the drinking water hose and electricity duct.

Once the service has ended, the satellite element released can retract on the collector drum until its original position within the buoy.

The drinking water and electricity supplies can come from the respective public networks, which should provide it with 10 kg/cm2 of pressure and 220V AC, respectively. The precise pressure limitation devices and, where appropriate, DC to AC conversion devices, can be placed inside the connection cabinet, and all for the purposes of providing, by means of the satellite elements, the suitable supplies in the conditions required for the suitable operation of the respective interior facilities of the craft served.

It is not considered necessary to go into greater detail concerning the material comprising the scope of the present invention, as well as the new effects and the technical benefits that may arise from it. The terms in which this report has been written should always be taken in the broadest and least limitative sense which is compatible with the essential nature of the invention described and claimed therein.

1. A buoy for mooring and supplying services to pleasure craft, such as have a body and a lower ring and are moored to a mooring post with an upper ring and a flat base that rests on the seabed, and such as are linked to the mooring post by means of a chain linking both rings, the buoy comprising:
a lower protection bell to protect a twin-tube supplying drinking water and electricity, and to avoid fraudulent direct mooring to the chain;
an upper retractable ring for mooring of the craft, and
a satellite element for supplies, housed in the body, and which can be released, the satellite element carrying ducts and a steel safety cable onboard for the purposes of being able to supply drinking water and electricity.

2. The buoy for mooring and supplying services to pleasure craft, according to claim 1, wherein the twin-tube supplying drinking water and electricity forms part of a distribution network, resting in its horizontal development on the seabed, and which starts from a connection cabinet located on the land part, opposite the marine space where the buoys are moored, their chains and their mooring posts, such as coves, and other protected places such as marinas.

3. The buoy for mooring and supplying services to pleasure craft, according to claim 1, characterized in that the upper retractable mooring ring can be activated by remote control or manually by a device configured to indicate authorization to perform the corresponding mooring.

4. The buoy for mooring and supplying services to pleasure craft, according to claim 1, wherein the satellite element, which can be released at the same time as the upper retractable ring, and extracted by a moving handle, has fast watertight sockets incorporated for drinking water and electricity.

5. The buoy for mooring and supplying services to pleasure craft, according to claim 1, comprising a drum inside the buoy for the winding around/unwinding of the drinking water hoses and electrical ducts, as well as of the steel safety cable, which connects the buoy to its satellite element.

6. The buoy for mooring and supplying services to pleasure craft, according to claim 3, wherein the device configured to indicate authorization to perform the corresponding mooring comprises a key, card with magnetic strip or a combination lock.
